(19) United States
(12) Patent Application Publication
(10) Pub. No.: US 2019/0315034 A1
(43) Pub. Date: Oct. 17, 2019

(54) Apparatus for injection molding of plastic materials

(71) Applicant: INGLASS S.p.A., San Polo di Piave (Treviso) (IT)

(72) Inventors: Riccardo VILLA, San Polo di Piave (Treviso) (IT); Nico TREVISIOL, San Polo di Piave (Treviso) (IT)

(21) Appl. No.: 16/382,295

(22) Filed: Apr. 12, 2019

(30) Foreign Application Priority Data
Apr. 16, 2018 (IT) 102018000004581

(51) Int. Cl. B29C 45/28; B29C 45/72; B29C 45/23

(52) U.S. Cl. CPC B29C 45/281; B29C 45/72; B29C 2045/1792; B29C 2045/7271; B29C 45/231

(57) ABSTRACT

An apparatus for injection molding of fluid plastic materials includes a mold, a hot runner distributor of the fluid plastic material, at least one injector, and an actuator for controlling the opening and closing of the injector, including a jack whose cooling is performed by means of an air flow.

### FIELD OF THE INVENTION

The present invention refers to apparatus for injection molding of plastic materials of the type comprising a mold, a hot runner distributor of the fluid plastic material, at least one injector for the introduction of the plastic material from the distributor into the mold cavity, and an actuator for controlling the opening and closing of the injector.

More in particular, the invention refers to molding apparatus thus made wherein the actuator which actuates the injector, typically provided with a valve pin axially displaceable between a full closing position and a maximum opening position of the injector, consists of a jack normally supported by the distributor.

### STATE OF THE PRIOR ART

During the operation of the molding apparatus, the jack, whether pneumatic or hydraulic or electric, is subjected to heating by means of the heat of the distributor, and it is conventionally cooled by means of an autonomous cooling hydraulic circuit. In some applications, even characterised by high temperatures of the mold, there arises the desire that the jack be without the cooling hydraulic circuit so as to make the molding apparatus easier and more economic.

The heat of the jack must however be dissipated, and solutions in which the cooling of the jack occurs by means of thermal exchange with at least one mold plate, for example the clamping plate, were proposed for this purpose.

Such solutions must take into account the phenomena regarding the thermal dilation regarding the hot runner which directly or indirectly supports the jack. For this reason, in such configuration for thermal dissipation by means of contact there must be provided solutions such as for example elastic thrust members suitable to allow that the thermal exchange surface between the cylinder of the jack and the plate ensures a constant thermal exchange contact.

The use of such elastic members entails construction complications and the thermal exchange between the jack and the plate made available by such elastic members is generally limited and thus scarcely efficient.

Documents US2014/353875 and US2014/037782 disclose the cooling of the actuator which controls the opening and closing of the injector by means of an air flow. These solutions are however scarcely efficient.

### SUMMARY OF THE INVENTION

The object of the present invention is to overcome the aforementioned drawbacks and provide an apparatus for injection molding of plastic materials of the type defined above that allows to obtain the cooling of the actuator, by means of an air flow, in a more efficient and functional manner.

With the aim of attaining such object, the peculiar characteristic of the invention lies in the fact that provided for is a casing at least partly surrounding the jack and having an air inlet opening and an outlet opening for the outflow of air.

In a preferred embodiment of the invention the air flow is generated by an electric fan.

In a first solution according to the invention, a casing surrounding the cylinder of the jack is provided for the optimal cooling of the jack by the air flow generated by the electric fan. The casing defines a flow path from an air inlet opening, advantageously provided for in a remote position with respect to the hot runner, to an air outflow opening arranged on the side of the jack opposite to the inlet opening. The casing can be at least partly made of a thermally insulating material and it can be at least in part insulated.

In an alternative solution the air flow generated by the electric fan is directed towards a body which at least partly encloses the cylinder of the jack and is at thermal exchange contact therewith.

The invention is applicable both to the case in which the jack is directly fixed to the hot runner and in the case it is indirectly fixed to the hot runner, for example laterally thereto.

### BRIEF DESCRIPTION OF THE DRAWINGS

The invention will now be described in detail with reference to the attached drawings, provided purely by way of non-limiting example, wherein:

FIG. 1 is a perspective view of a part of an apparatus for injection molding of plastic materials according to the invention,

FIG. 2 is a lateral elevational view of FIG. 1, and

FIG. 3 is a vertical sectional schematic view showing a variant of the invention.

### DETAILED DESCRIPTION

An apparatus for injection molding of plastic materials conventionally comprises a press (not illustrated) for sending the fluid plastic material to a distributor or hot runner 1 from which the plastic material is injected into the mold cavity (not illustrated) through one or more injectors. Each injector comprises a valve pin 2 displaceable, relatively to a mold gate, between a full closing position and a maximum opening position. The displacement of the valve pin 2, and thus the opening and closing of the injector, is carried out by an actuator which, in the case of the present invention, consists of a jack indicated in its entirety with 3, pneumatic or hydraulic or electric.

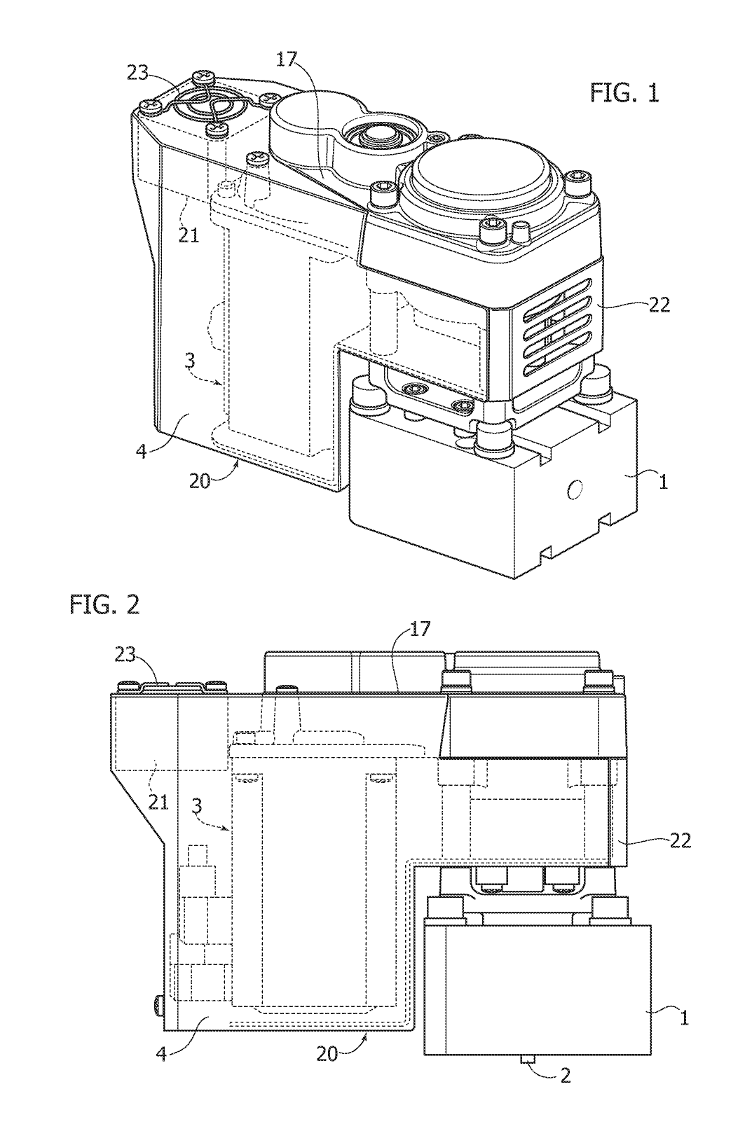

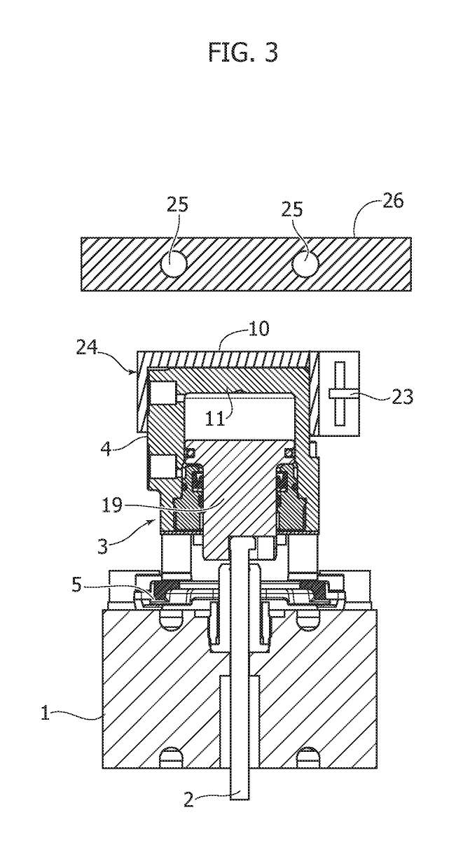

In the case of the example described herein with reference to FIGS. 1 and 2, the jack 3 consists of an electric actuator and it comprises a cylinder or body 4 which is supported by distributor 1 indirectly, adjacent to the latter. In the case of FIG. 3 the jack 3 is of the fluid type and it includes a plunger 19 to which the valve pin 2 is connected directly or indirectly. In this case the cylinder 4 of the jack 3 is instead directly fixed onto the distributor 1 by means of a fixing unit generally indicated with 5.

The body 4 is without an independent cooling circuit which conventionally uses cooling liquid, and according to the peculiar characteristic of the invention, the cooling thereof is performed by means of a pressurised air flow.

Still with reference to FIGS. 1 and 2 the jack 3 is laterally fixed to the hot runner 1 by means of a support 17 bearing a mechanical transmission (not visible) for the actuation of the valve pin 2 of the injector. A casing 20 at least partly, and preferably fully, surrounds the cylinder or body 4 so as to define a cooling flow path from an inlet opening 21 provided for on the support 17, to a grid outlet opening 22 provided for on a lateral wall of the casing 20, on the side of the hot runner 1. The casing 20 is closed—at the upper part—by the support 17, it is conveniently at least partly made of a thermally insulating material, and it can also be at least partly insulated.

In the described embodiment the inlet opening 21 is conveniently provided at a remote position with respect to the hot runner 1 so that the air flowing into the flow path is not affected by the heating of the hot runner 1. An electric fan 23 is arranged in the opening so as to introduce the air suctioned from the external environment into the path defined by the casing and which touches the cylinder 4. The air flow removes by convection the heat of the cylinder 4 and flows through the opening 22 towards the external environment. Suitably adjusting the air flow rate in the casing by dimensioning the electric fan 23 and its operating regime allows maintaining the cylinder 4 and thus the entire fluid jack 3 at an optimal operating temperature.

As previously mentioned, FIG. 3 represents an alternative embodiment of the invention in which the jack 3, of the fluid type in this case, is directly supported on the hot runner 1. A hollow body 24, having an end radial wall 10 facing a bottom plate 11 of the cylinder 4 and conventionally made of thermally conductive material, partly surrounding the cylinder 4 and it supports the fan 23 suitable for the cooling thereof. The hollow body 24 could also consist of several parts, and several electric fans 23 could also be provided for.

In this embodiment it can be convenient, in order to improve the cooling action carried out by the electric fan 23, to provide in the apparatus solutions suitable to convey the air flow outside the mold. These solutions may for example consist of canalizations 25 obtained through a mold plate, typically the clamping plate 26 thereof.

In a further embodiment, not represented in the drawings, the air flow produced by the fan 23 could be directly directed to the cylinder 4.

In light of the above it will be clear that the invention is capable of ensuring, during the operation of the molding apparatus, an efficient heat dissipation of the hydraulic jack 3 in a constructively easy manner.

Obviously, the construction details and the embodiments may widely vary with respect to what has been described and illustrated, without departing from the scope of protection of the invention as set forth in the claims that follow. Thus, for example, in the embodiment of FIGS. 1 and 2 the electric fan 23 could be arranged at the outlet opening 22, and it could be of the suctioning type in this case. Furthermore, the jack 3 could also be directly or indirectly supported by a mold plate, in particular by the clamping plate 26 of the mold, instead of by the distributor 1.

1. An apparatus for injection molding of fluid plastic materials, comprising:
a mold,
a hot runner distributor of the fluid plastic material,
at least one injector for injecting the fluid plastic material from the hot runner distributor into the mold,
a jack controlling opening and closing of the injector, said jack being cooled by an air flow, and
a casing at least partly surrounding the jack, said casing having an air inlet opening and an outlet opening for the outflow of air.

2. The apparatus according to claim 1, wherein said air flow is generated by an electric fan.

3. The apparatus according to claim 2, wherein said electric fan is arranged at said air inlet opening.

4. The apparatus according to claim 2, wherein said electric fan is arranged at said outlet opening.

5. The apparatus according to claim 3, wherein said air inlet opening is at a remote position with respect to said hot runner.

6. The apparatus according to claim 3, wherein said casing is at least partly made of a thermally insulating material.

7. The apparatus according to claim 2, wherein the jack includes a cylinder, and wherein provided for is at least one hollow body which at least partly surrounds the cylinder of the jack, said at least one hollow body being designed to support at least said electric fan.

8. The apparatus according to claim 2, wherein the air flow generated by said electric fan is conveyed outside the mold.

9. The apparatus according to claim 1, wherein the jack is supported by the hot runner distributor.

10. The apparatus according to claim 1, wherein the jack is supported by a mold plate.

11. The apparatus according to claim 1, wherein the jack is electric.

12. The apparatus according to claim 1, wherein the jack is a fluid jack.
